(19) United States
(12) Patent Application Publication
(10) Pub. No.: US 2026/0181446 A1
(43) Pub. Date: Jun. 25, 2026

(54) RRC Procedure for QoE Reporting to a Secondary Node

(71) Applicant: Apple Inc., Cupertino, CA (US)

(72) Inventors: Ping-Heng KUO, London (GB); Fangli XU, Beijing (CN)

(21) Appl. No.: 19/126,342

(22) PCT Filed: Nov. 2, 2022
(86) PCT No.: PCT/CN2022/129316

§ 371 Date: May 1, 2025

(51) Int. Cl. H04W 24/10; H04W 28/06; H04W 48/16; H04W 76/27

(52) U.S. Cl. CPC H04W 24/10; H04W 28/06; H04W 48/16; H04W 76/27

(57) ABSTRACT

A user equipment (UE) is configured to generate a quality of experience (QoE) report by a Radio Resource Control (RRC) layer and determine whether to transmit the QoE report to a master node (MN) or a secondary node (SN). When it is determined to transmit the QoE report to the SN, the UE determines whether a primary path of a packet data convergence protocol (PDCP) entity refers to a master cell group (MCG) and PDCP duplication is not configured.

### TECHNICAL FIELD

This application relates generally to wireless communication systems, and in particular relates to RRC procedure for QoE reporting to a secondary node.

### BACKGROUND

In 5G New Radio (NR), quality of experience (QoE) management may be implemented to monitor user-perceived quality of experience when using certain services. For example, 5G NR QoE measurement mechanisms may collect application layer measurements for services such as, but not limited to, enhanced mobile broadband (eMBB), ultra-reliable low latency communication (URLLC), streaming, multimedia telephony service over IMS (MTSI), multimedia broadcast multicast services (MBMS), extended reality (XR), virtual reality (VR), etc.

5G NR QoE management may also include mechanisms for activation, deactivation, configuration, mobility support and reporting QoE measurements. Current implementations of QoE reporting only supports QoE reporting via a Master Cell Group (MCG) (i.e., QoE reporting to a Master Node (MN) ). QoE reporting to Secondary Nodes (SNs) is currently undefined.

### SUMMARY

In some exemplary embodiments a method is performed by a user equipment (UE). The method includes generating a quality of experience (QoE) report by a Radio Resource Control (RRC) layer and determining whether to transmit the QoE report to a master node (MN) or a secondary node (SN). The method further includes when it is determined to transmit the QoE report to the SN, determining whether a primary path of a packet data convergence protocol (PDCP) entity refers to a master cell group (MCG) and PDCP duplication is not configured. The method further includes when the primary path refers to the MCG and PDCP duplication is not configured, setting the primary path of the PDCP entity to refer to a secondary cell group (SCG), submitting, by the RRC layer, the QoE report to the PDCP entity in a PDCP layer and transmitting the QoE report to the SN.

Other exemplary embodiments are related to a method performed by a user equipment (UE). The method includes receiving a quality of experience (QoE) configuration from a network, generating a quality of experience (QoE) report and determining whether the QoE configuration was transmitted from the network via signaling radio bearer 3 (SRB3) or SRB1.

Still further exemplary embodiments are related to a method performed by a user equipment (UE). The method includes generating a quality of experience (QoE) report by a Radio Resource Control (RRC) layer, encoding the QoE report in a transparent container and transmitting a message to a master node (MN) comprising the transparent container including the QoE report and an indication that the transparent container is to be forwarded to a secondary node (SN).

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary base station according to various exemplary embodiments.

FIG. 4 shows a flow diagram for QoE reporting via only split SRB according to various exemplary embodiments.

FIG. 5 shows a flow diagram for QoE reporting via split and SN-only SRB according to various exemplary embodiments.

FIG. 6 shows a flow diagram for bearer selection for QoE reporting to an SN according to various exemplary embodiments.

### DETAILED DESCRIPTION

The exemplary embodiments may be further understood with reference to the following description and the related appended drawings, wherein like elements are provided with the same reference numerals. The exemplary embodiments relate to Radio Resource Control (RRC) procedures for QoE reporting to secondary nodes (SNs).

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with reference to a 5G New Radio (NR) network. However, it should be understood that the exemplary embodiments may also be implemented in other types of networks, including but not limited to LTE networks, future evolutions of the cellular protocol, or any other type of network.

3GPP has defined an application layer measurement reporting framework. A UE may be configured to perform application layer measurements corresponding to an application on the UE, e.g., an application executing on the UE. The UE may receive a measurement report from the application and generate an application layer measurement report or a QoE report to report the application layer measurements to a network. In this disclosure, an application layer measurement may also mean a QoE measurement, and vice versa, and an application layer measurement report may also mean a QoE report, and vice versa.

A QoE report, in general, may be utilized by the network for various purposes, including but not limited to, optimization of the network and/or the radio access network (RAN), collecting statistical information for analysis, etc.

In particular, the application layer measurement report or the QoE report may be allocated to one or a plurality of segments, and the one or plurality of segments may be transmitted to the network using a radio bearer (e.g., a signaling radio bearer 4(SRB4 ) ) via a master node (MN) in a master cell group (MCG) and/or a secondary node (SN) in a secondary cell group (SCG). As described above, QoE reporting to Secondary Nodes (SNs) is currently undefined.

SRB4 has been defined by 3GPP for application measurement reporting. Currently, SRB4 only supports QoE reporting via a MCG. It is possible that future iterations of 3GPP protocols will support both split SRB4 and SN-only SRB for QoE reporting. Proposed herein are four primary aspects of the exemplary embodiments directed to QoE reporting to SNs.

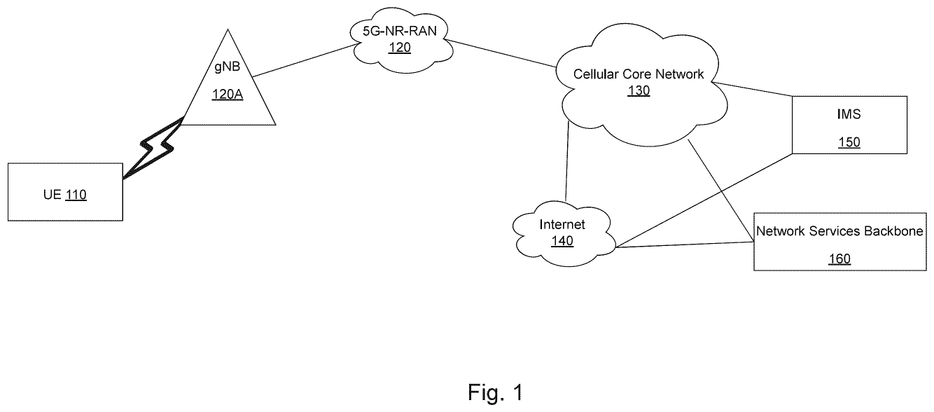

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., 5G cloud RAN, a next generation RAN (NG-RAN), a legacy cellular network, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be portions of a cellular network that may be deployed by a network carrier (e. g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

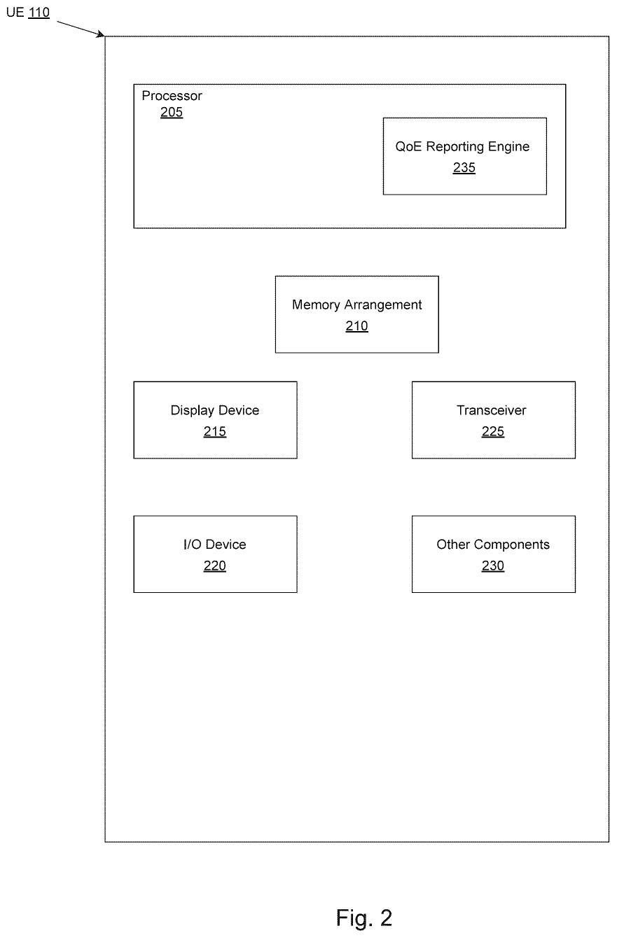

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a QoE reporting engine 235 for performing operations such as determining a QoE destination node, determining a primary path of a PDCP entity, and submitting RRC protocol data units (PDUs) to a lower layer for transmission.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120. Accordingly, the transceiver 225 may operate on a variety of different frequencies or channels (e.g., set of consecutive frequencies).

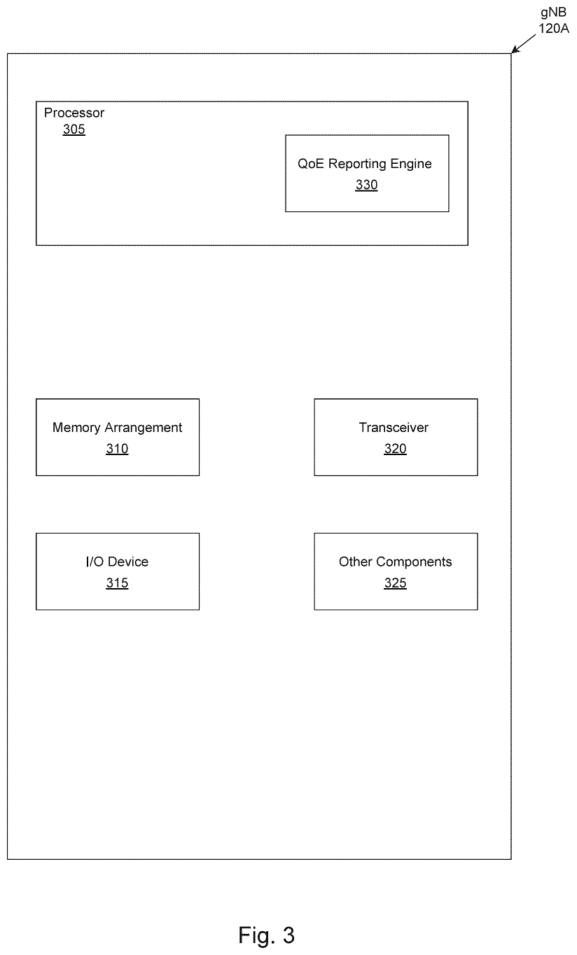

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the UE 110. For example, the engines may include a QoE reporting engine 330 for performing operations such as determining a QoE destination node, determining a primary path of a PDCP entity, and submitting RRC protocol data units (PDUs) to lower layers for transmission.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

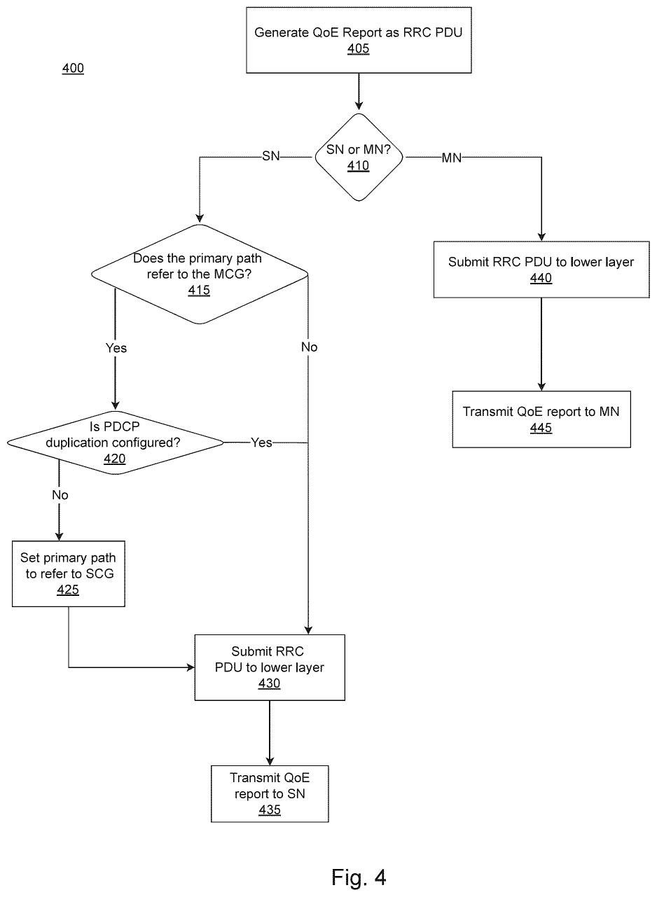

In a first aspect of the exemplary embodiments, an RRC procedure applicable when only a split SRB is supported is disclosed. FIG. 4 shows a flow diagram 400 for QoE reporting via only a split SRB according to various exemplary embodiments. Flow diagram 400 may be understood to occur at UE 110, though use of UE 110 is only exemplary.

In 405, the UE 110 generates a QoE report (e.g., an application layer measurement report) as a Radio Resource Control (RRC) Protocol Data Unit (PDU). As described above, 5G NR QoE measurement mechanisms may collect experience parameters for services such as eMBB, URLLC, streaming, MTSI, MBMS, and XR.

In 410, the UE 110 determines if the generated QoE report 405 is intended to be transmitted to an MN or to an SN. Disclosed first is the situation in which the transmission is intended for an SN, in 415.

In 415, the UE 110 determines whether the primary path of an associated Packet Data Convergence Protocol (PDCP) entity refers to an MCG. If the answer to 415 is no, the UE 110 proceeds to 430, to be discussed below. If the answer to 415 is yes, the UE proceeds to 420.

In 420, the UE 110 determines whether PDCP duplication is allowed. If PDCP duplication is allowed, the UE 110 proceeds to 430. If PDCP duplication is not allowed, the UE 110 proceeds to 425. In 425, the UE 110 sets the primary path to refer to an SCG. Following 425, the UE 110 proceeds to 430.

As mentioned above, when the answer to 415 is no, or the answer to 420 is yes, the UE proceeds to 430. In 430, the UE 110 submits the RRC PDU (e.g., the generated QUE report) to a lower layer for transmission. In 435, the UE 110 transmits the QoE report to the SN.

Returning to 410, if the UE 110 determines that the QoE report 405 is to be transmitted to the MN, the UE 110 proceeds to 440. In 440, the UE 110 submits the RRC PDU (e.g., the QoE report) to a lower layer. In 445, the UE 110 transmits the QoE report to the MN.

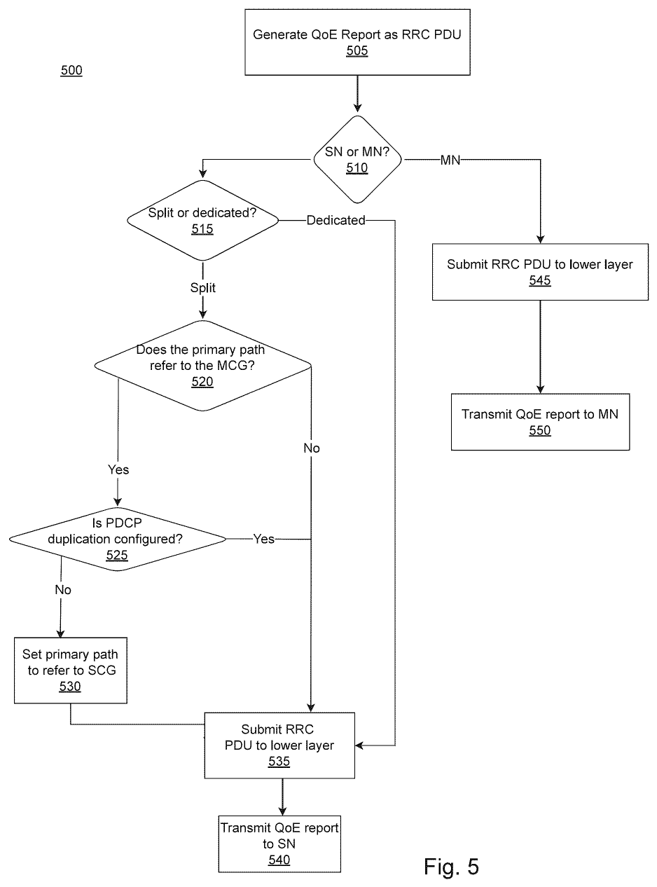

In a second aspect of the exemplary embodiments, an RRC procedure applicable when split SRB and SN-only SRB are supported is disclosed herein. FIG. 5 shows a flow diagram 500 for QoE reporting via split and SN-only SRB according to various exemplary embodiments.

Flow diagram 500 is substantially similar to flow diagram 400. Whereas flow diagram 400 shows a QoE reporting flow when only split SRB is supported, flow diagram 500 shows a QoE reporting flow when both split and SN-only reporting is supported. The pertinent difference between these two flow diagrams is 515.

In 515, the UE 110 must determine whether the radio bearer for QUE reporting is configured as a split bearer (e.g., split SRB4), or, if the UE 110 has a radio bearer dedicated to SN that may support QoE reporting (e.g., SRB3, SRB4 configured as an SCG bearer). If the answer to 515 is that the bearer is a split bearer, the UE 110 proceeds to 520. 520 proceeds identically to operation 415 described in FIG. 4. If the answer to 515 is that the bearer is a dedicated SN bearer, the UE 110 proceeds to 535. 535 proceeds identically to 430 as described in FIG. 4.

In a third aspect of the exemplary embodiments, container-based reporting for QoE reports to SNs is disclosed. The third aspect applies to scenarios in which only SRB4 connections to the MN are supported (e.g., there is no direct connection from the SN to the UE for QoE reporting).

A UE may include a QoE report (that is intended for an SN) as a transparent container in a message to the MN. When the MN receives the message, it may forward the transparent container to the SN. The MN itself may not read the transparent container. The SN may then extract the forwarded transparent container to obtain the QoE report from the UE.

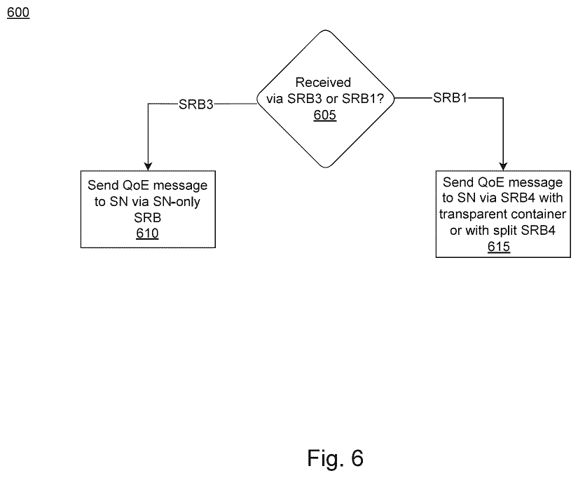

In a fourth aspect of the exemplary embodiments, UE bearer selection for QoE reporting is disclosed. A UE may decide which bearer that it should send a QoE report intended for an SN, based on how the UE received the configuration for QoE reporting. FIG. 6 shows a flow diagram 600 for bearer selection for QoE reporting to an SN according to various exemplary embodiments.

At 605, the UE 110 determines how it received the configuration for QoE reporting. If the UE 110 determines that the configuration was received via SRB3 (i.e., configured by the SN), the UE 110 proceeds to 610. At 610, the UE 110 may send the QUE report intended to an SN via an SN-only SRB. Examples of SN-only SRB include SRB3, SRBX, or SRB4 configured as a SCG-bearer.

If the UE 110 determines that the configuration was received via SRB1 (i.e., configured by the MN), the UE 110 may send the QoE report intended to an SN via SRB4 with a transparent container (e.g., the third aspect), or via split SRB4, as described in the first and second aspect.

### EXAMPLES

In a first example, a method is performed by a base station operating as a master node (MN), comprising receiving a message from a user equipment (UE) comprising a quality of experience (QoE) report in a transparent container and transmitting the transparent container to a secondary node (SN).

In a second example, a processor performs the method of the first example.

In a third example, a base station comprises a transceiver to communicate with a user equipment (UE) and a processor communicatively coupled to the transceiver and configured to perform the method of the first example.

In a fourth example, a processor is configured to generate a quality of experience (QoE) report by a Radio Resource Control (RRC) layer and determine whether to transmit the QoE report to a master node (MN) or a secondary node (SN).

In a fifth example, the processor of the fourth example, further configured to, when it is determined to transmit the QoE report to the MN, submit, by the RRC layer, the QoE report to a packet data convergence protocol (PDCP) entity in a PDCP layer and transmit the QoE report to the MN.

In a sixth example, the processor of the fourth example, further configured to, when it is determined to transmit the QoE report to the SN, determine whether a primary path of a packet data convergence protocol (PDCP) entity refers to a master cell group (MCG) and PDCP duplication is not configured.

In a seventh example, the processor of the sixth example, further configured to, when the primary path refers to the MCG and PDCP duplication is not configured, set the primary path of the PDCP entity to refer to a secondary cell group (SCG), submit, by the RRC layer, the QoE report to the PDCP entity in a PDCP layer and transmit the QoE report to the SN.

In an eighth example, the processor of the sixth example, further configured to, when the primary path does not refer to the MCG or PDCP duplication is configured, submit, by the RRC layer, the QoE report to the PDCP entity in a PDCP layer and transmit the QoE report to the SN.

In a ninth example, the processor of the fourth example, further configured to, when it is determined to transmit the QoE report to the SN, determine whether a radio bearer for QoE reporting is configured as a split bearer or a dedicated SN bearer.

In a tenth example, the processor of the ninth example, further configured to, when it is determined the radio bearer for QoE reporting is configured as the split bearer, determine a primary path of a packet data convergence protocol (PDCP) entity refers to a master cell group (MCG) and PDCP duplication is not configured, set the primary path of the PDCP entity to refer to a secondary cell group (SCG), submit, by the RRC layer, the QoE report to the PDCP entity in a PDCP layer and transmit the QoE report to the SN via the split bearer.

In an eleventh example, the processor of the ninth example, further configured to, when it is determined the radio bearer for QoE reporting is configured as the dedicated SN bearer, submit, by the RRC layer, the QoE report to the PDCP entity in a PDCP layer and transmit the QoE report to the SN via the dedicated SN bearer.

In a twelfth example, the processor of the ninth example, wherein the split bearer is a signaling radio bearer 4 (SRB4).

In a thirteenth example, the processor of the ninth example, wherein the dedicated SN bearer is a signaling radio bearer 4(SRB4 ), a SRB3, or any type of SRB connecting to the SN only.

In a fourteenth example, the processor of the fourth example, wherein the QoE report comprises an application layer measurement report.

In a fifteenth example, the processor of the fourth example, wherein the QoE report comprises a RRC Protocol Data Unit (PDU).

In a sixteenth example, a user equipment comprising a transceiver configured to communicate with a network and the processor of any of the fourth through fifteenth examples.

In a seventeenth example, a processor is configured to receive a quality of experience (QoE) configuration from a network, generate a quality of experience (QoE) report, and determine whether the QoE configuration was transmitted from the network via signaling radio bearer 3 (SRB3) or SRB1.

In an eighteenth example, the processor of the seventeenth example is further configured to, when the QUE configuration was transmitted from the network via SRB3, transmit the QoE report to a secondary node (SN) via a dedicated SN bearer.

In a nineteenth example, the processor of the eighteenth example, wherein the SN-only SRB comprises SRB3, SRB4 or any type of SRB configured as a secondary cell group (SCG) bearer.

In a twentieth example, the processor of the seventeenth example is further configured to, when the QoE configuration was transmitted from the network via SRB1, transmit the QoE report to a secondary node (SN).

In a twenty first example, the processor of the twentieth example, wherein the transmitted QoE report is relayed through a master node (MN) in a transparent container before arriving at the SN.

In a twenty second example, the processor of the twentieth example is further configured to determine whether to transmit the QoE report to a MN or to an SN, determine whether a primary path of a packet data convergence protocol (PDCP) refers to a master node (MN) or a secondary node (SN), determine whether PDCP duplication is configured, set a primary path of a PDCP entity to refer to a secondary cell group (SCG), determine whether a radio bearer for QoE reporting is configured as a split bearer or a dedicated SN bearer and submit the QUE report to a lower layer.

In a twenty third example, a user equipment comprising a transceiver configured to communicate with a network and the processor of any of the seventeenth through twenty second examples.

In a twenty fourth example, a processor is configured to generate a quality of experience (QoE) report by a Radio Resource Control (RRC) layer, encode the QoE report in a transparent container, and transmit a message to a master node (MN) comprising the transparent container including the QoE report and an indication that the transparent container is to be forwarded to a secondary node (SN).

In a twenty fifth example, a user equipment comprising a transceiver configured to communicate with a network and the processor of the twenty fourth example.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above-described method may be embodied as a program containing lines of code stored on a non-transitory computer readable storage medium that, when compiled, may be executed on a processor or microprocessor.

Although this application described various aspects each having different features in various combinations, those skilled in the art will understand that any of the features of one aspect may be combined with the features of the other aspects in any manner not specifically disclaimed or which is not functionally or logically inconsistent with the operation of the device or the stated functions of the disclosed aspects.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method performed by a user equipment (UE), comprising:
generating a quality of experience (QoE) report by a Radio Resource Control (RRC) layer; and
determining whether to transmit the QoE report to a master node (MN) or a secondary node (SN).

2. The method of claim 1, further comprising:
when it is determined to transmit the QoE report to the MN, submitting, by the RRC layer, the QoE report to a packet data convergence protocol (PDCP) entity in a PDCP layer; and
transmitting the QoE report to the MN.

3. The method of claim 1, further comprising:
when it is determined to transmit the QoE report to the SN, determining whether a primary path of a packet data convergence protocol (PDCP) entity refers to a master cell group (MCG) and PDCP duplication is not configured.

4. The method of claim 3, further comprising:
when the primary path refers to the MCG and PDCP duplication is not configured, setting the primary path of the PDCP entity to refer to a secondary cell group (SCG);
submitting, by the RRC layer, the QoE report to the PDCP entity in a PDCP layer; and
transmitting the QoE report to the SN.

5. The method of claim 3, further comprising:
when the primary path does not refer to the MCG or PDCP duplication is configured, submitting, by the RRC layer, the QoE report to the PDCP entity in a PDCP layer; and
transmitting the QoE report to the SN.

6. The method of claim 1, further comprising:
when it is determined to transmit the QoE report to the SN, determining whether a radio bearer for QoE reporting is configured as a split bearer or a dedicated SN bearer.

7. The method of claim 6, further comprising:
when it is determined the radio bearer for QoE reporting is configured as the split bearer, determining a primary path of a packet data convergence protocol (PDCP) entity refers to a master cell group (MCG) and PDCP duplication is not configured;
setting the primary path of the PDCP entity to refer to a secondary cell group (SCG);
submitting, by the RRC layer, the QoE report to the PDCP entity in a PDCP layer; and
transmitting the QoE report to the SN via the split bearer.

8. The method of claim 6, further comprising:
when it is determined the radio bearer for QoE reporting is configured as the dedicated SN bearer, submitting, by the RRC layer, the QoE report to a packet data convergence protocol (PDCP) entity in a PDCP layer; and
transmitting the QoE report to the SN via the dedicated SN bearer.

9. The method of claim 6, wherein the split bearer is a signaling radio bearer 4 (SRB4).

10. The method of claim 6, wherein the dedicated SN bearer is a signaling radio bearer 4(SRB4 ), a SRB3, or any type of SRB connecting to the SN only.

11. The method of claim 1, wherein the QoE report comprises an application layer measurement report.

12. The method of claim 1, wherein the QoE report comprises a RRC Protocol Data Unit (PDU).

13. A method performed by a user equipment (UE), comprising:
receiving a quality of experience (QoE) configuration from a network;
generating a quality of experience (QoE) report; and
determining whether the QoE configuration was transmitted from the network via signaling radio bearer 3 (SRB3) or SRB1.

14. The method of claim 13, further comprising:
when the QoE configuration was transmitted from the network via SRB3, transmitting the QoE report to a secondary node (SN) via a dedicated SN bearer.

15. The method of claim 14, wherein the dedicated SN bearer comprises SRB3, SRB4 or any type of SRB configured as a secondary cell group (SCG) bearer.

16. The method of claim 13, further comprising:
when the QoE configuration was transmitted from the network via SRB1, transmitting the QoE report to a secondary node (SN).

17. The method of claim 16, wherein the QoE report is relayed through a master node (MN) in a transparent container before arriving at the SN.

18. The method of claim 16, further comprising:
determining whether to transmit the QoE report to a MN or to an SN;
determining whether a primary path of a packet data convergence protocol (PDCP) refers to a master node (MN) or a secondary node (SN);
determining whether PDCP duplication is configured;
setting a primary path of a PDCP entity to refer to a secondary cell group (SCG);
determining whether a radio bearer for QoE reporting is configured as a split bearer or a dedicated SN bearer; and
submitting the QoE report to a lower layer.

19. A method performed by a user equipment (UE), comprising:
generating a quality of experience (QoE) report by a Radio Resource Control (RRC) layer;
encoding the QoE report in a transparent container; and
transmitting a message to a master node (MN) comprising the transparent container including the QoE report and an indication that the transparent container is to be forwarded to a secondary node (SN).
